(19) United States
(12) Patent Application Publication
(10) Pub. No.: US 2016/0321620 A1
(43) Pub. Date: Nov. 3, 2016

(54) METHOD AND APPARATUS FOR IMPLEMENTING A GATEWAY FOR MANAGING USER SUBSCRIPTIONS

(71) Applicant: YipTV, Inc., West Palm Beach, FL (US)

(72) Inventors: Tribolet Michael, Riviera Beach, FL (US); Achinth Gurkhi, Chikkalasandra (IN)

(21) Appl. No.: 15/144,696

(22) Filed: May 2, 2016

Related U.S. Application Data
(60) Provisional application No. 62/155,946, filed on May 1, 2015.

(51) Int. Cl. G06Q 20/02; G06F 17/30

(52) U.S. Cl. CPC G06Q 20/027; G06F 17/30528; G06F 17/30371

(57) ABSTRACT

A method and apparatus may include receiving a request to generate a new merchant record for a merchant. The request is received from a location of the merchant. The method may also include determining whether the merchant record should be generated. The method may also include generating and storing the merchant record based upon the first determination. The method may also include receiving a request to generate a new subscriber record for a subscriber. The request is received from the location of the merchant. The subscriber record indicates an association between the subscriber and the merchant. The method may also include determining whether the subscriber record should be generated. The method may also include generating and storing the subscriber record based upon the second determination.

### BACKGROUND

Embodiments of the present invention relate to implementing a gateway for managing user subscriptions.

Content delivery networks may provide content to end-users via an internet content delivery network (CDN). A CDN is a network of geographically distributed system of servers that arrange for efficient delivery of content on behalf of third party content providers. The provided content may include, but is not limited to, media files, electronic documents, application data, on-demand data, and live-streamed data, for example. The end-users of content delivery networks may be subscribers/customers that pay a subscription price in order to have access to the provided content. A gateway may be utilized in order to register new subscribers/customers and to process customer payments.

### SUMMARY

According to a first embodiment, a method may include receiving, by a network device, a request to generate a new merchant record for a merchant. The request may be received from a location of the merchant. The method may also include determining whether the merchant record should be generated. The method may also include generating and storing the merchant record based upon the first determination. The method may also include receiving a request to generate a new subscriber record for a subscriber. The request may be received from the location of the merchant, and the subscriber record may indicate an association between the subscriber and the merchant. The method may also include determining whether the subscriber record should be generated. The method may also include generating and storing the subscriber record based upon the second determination.

In the method of the first embodiment, the network device may include a merchant gateway.

In the method of the first embodiment, the method may also include generating and storing a payment record. The payment record may reflect a payment by the subscriber, and each payment record may be stored into a queue to be processed by a daemon program.

In the method of the first embodiment, the method may also include generating a reconciliation report for the merchant. The reconciliation report may indicate subscribers that the merchant has originated, and the reconciliation report may indicate payments received by the merchant.

In the method of the first embodiment, the generating and the storing the subscriber record may include utilizing representational state transfer application programming interfaces.

In the method of the first embodiment, the subscriber record may indicate whether the merchant originated the subscriber or whether the subscriber is an existing subscriber.

In the method of the first embodiment, the determining whether the merchant record should be generated may include determining whether the merchant record has already been previously generated.

According to a second embodiment, an apparatus may include at least one processor. The apparatus may also include at least one memory including computer program code. The at least one memory and the computer program code may be configured, with the at least one processor, to cause the apparatus at least to receive a request to generate a new merchant record for a merchant. The request may be received from a location of the merchant. The apparatus may also be caused to determine whether the merchant record should be generated. The apparatus may also be caused to generate and store the merchant record based upon the first determination. The apparatus may also be caused to receive a request to generate a new subscriber record for a subscriber. The request may be received from the location of the merchant, and the subscriber record indicates an association between the subscriber and the merchant. The apparatus may also be caused to determine whether the subscriber record should be generated. The apparatus may also be caused to generate and store the subscriber record based upon the second determination.

In the apparatus of the second embodiment, the apparatus may include a merchant gateway.

In the apparatus of the second embodiment, the apparatus may be further caused to generate and store a payment record. The payment record may reflect a payment by the subscriber, and each payment record may be stored into a queue to be processed by a daemon program.

In the apparatus of the second embodiment, the apparatus may be further caused to generate a reconciliation report for the merchant. The reconciliation report may indicate subscribers that the merchant has originated, and the reconciliation report indicates payments received by the merchant.

In the apparatus of the second embodiment, the generating and the storing the subscriber record may include utilizing representational state transfer application programming interfaces.

In the apparatus of the second embodiment, the subscriber record may indicate whether the merchant originated the subscriber or whether the subscriber is an existing subscriber.

In the apparatus of the second embodiment, the determining whether the merchant record should be generated may include determining whether the merchant record has already been previously generated.

According to a third embodiment, a computer program product may be embodied on a non-transitory computer readable medium. The computer program product may be configured to control a processor to perform a method according to the first embodiment.

### BRIEF DESCRIPTION OF THE DRAWINGS

For proper understanding of the invention, reference should be made to the accompanying drawings, wherein:

FIG. 1 illustrates an arrangement between a merchant gateway and a plurality of merchants in accordance with certain embodiments of the present invention.

FIG. 2 illustrates an arrangement between a merchant gateway, a media interface, and a billing utility, in accordance with certain embodiments of the present invention.

FIG. 3 illustrates a merchant gateway that utilizes a queue, in accordance with certain embodiments of the present invention.

FIG. 4 illustrates a flowchart of a method in accordance with certain embodiments of the present invention.

FIG. 5 illustrates an apparatus in accordance with certain embodiments of the present invention.

FIG. 6 illustrates an apparatus in accordance with certain embodiments of the present invention.

FIG. 7 illustrates an arrangement between clients, third party entities, external services and a content provider server in accordance with certain embodiments of the present invention.

FIG. 8 illustrates a graphical user interface displayed to a user/subscriber in accordance with certain embodiments of the present invention.

FIG. 9 illustrates a graphical user interface displayed to a user/subscriber in accordance with certain embodiments of the present invention.

FIG. 10 illustrates a graphical user interface displayed to a user/subscriber in accordance with certain embodiments of the present invention.

### DETAILED DESCRIPTION

This invention discloses several embodiments for implementing a gateway for managing user subscriptions. This description uses terms such as “one embodiment” or “an embodiment” to mean that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

For purposes of understanding the invention, it should be understood that terms “component,” “module,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Further, it should be understood that various embodiments of systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

In addition, the embodiments of systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

Certain embodiments of the present invention relate to implementing a gateway for managing user subscriptions. A gateway is generally a computer, server or other device that runs software configured to perform the tasks of a gateway by serving as a network node capable of interfacing with another network that uses different protocols. The user subscriptions can correspond to subscriptions of customers who have subscribed to a service provided by a content delivery network. The gateway may enable different parties to manage user subscriptions from a plurality of different geographically dispersed locations that are associated with the content delivery network.

For example, certain embodiments of the present invention may allow third parties (who may be associated with the content delivery network) to manage subscribers that are subscribed with the content delivery network. These third parties may include, for example, merchants that are in contact with both existing subscribers and potential subscribers. These merchants may have specific expertise in obtaining new subscribers for the content delivery network.

Certain embodiments of the present invention may enable operators of a content delivery network to obtain/register new subscribers/users who were generally unreachable by the previous approaches for registering subscribers, as described in more detail below. The previous approaches generally required subscribers to individually visit one central website to register and to provide payment to the content delivery network. With the previous approaches, the registration and payment would generally be processed in a centralized manner. In contrast with the previous approaches, the subscribers may visit various geographically distributed third parties locations to register and provide payment to the content delivery network by use of a gateway provided at such locations. The gateway may allow each third party to register new subscribers and to collect payment at its own location. For example, a merchant may access the gateway from a store belonging to the merchant, and the merchant may thus register new subscribers and collect payment directly from its own store.

Enabling a merchant to register new subscribers and to collect payments directly from its own store may be advantageous because certain customers may prefer to register and to provide payment in-person, as opposed to registering and providing payment online. This concept also allows customers to pay via methods that are not readily available through traditional methods of registering on the internet, such as cash or check. As such, certain embodiments may enable operators of a content delivery network to be able to more readily register and collect payment from these customers who prefer to perform transactions in person, as compared to the previous approaches.

Certain embodiments of the present invention may be directed to a gateway that comprises certain software tools (such as command-line interface (CLI) tools, for example), certain portals, and/or Application Programming Interfaces (APIs), for example. The APIs may be Representational State Transfer (REST) Application Programming Interfaces (APIs). As described above, by using these tools, portals, and APIs, third parties (such as merchants, for example) may register new subscribers and may process payments.

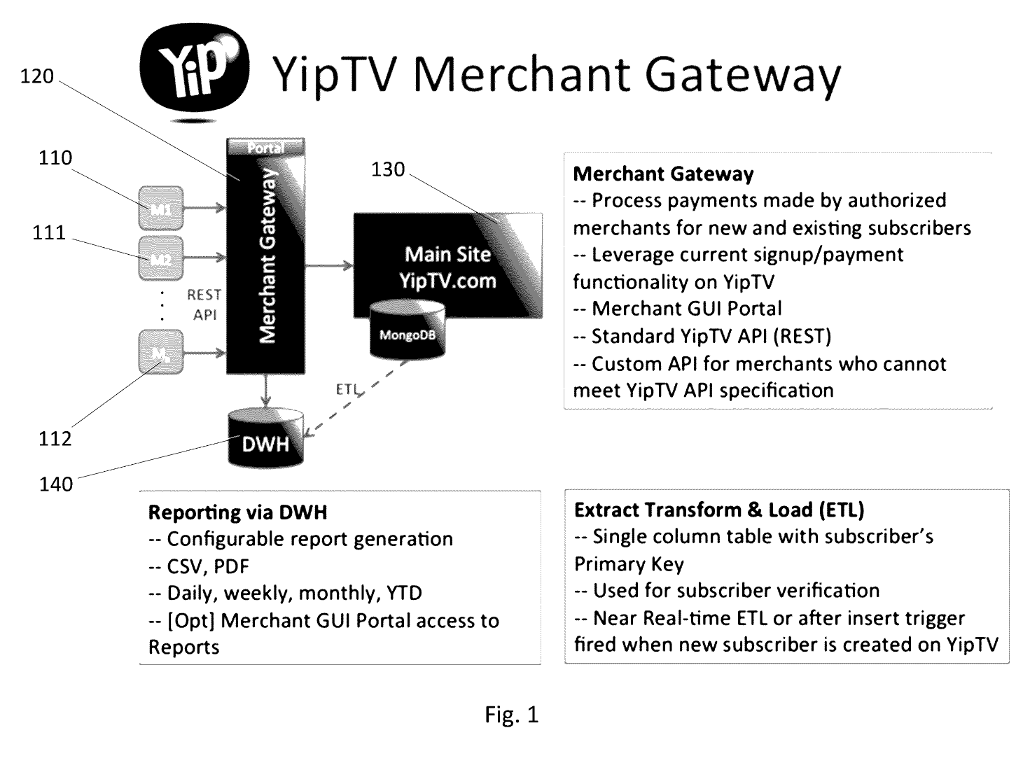

Referring to FIG. 1, FIG. 1 illustrates an arrangement between a merchant gateway and a plurality of merchants in accordance with certain embodiments of the present invention. Merchant gateway 120 may be in communication with a plurality of merchants 110-112. At the plurality of merchants 110-112, a merchant enters subscriber information for one subscriber using an API. Merchant gateway 120 may also be in communication with a main site of the content delivery network. Data warehouse (DWH) 140 may be a reconciliation database. DWH 140 may reconcile between a content delivery network (such as Yip) and merchant records (where the merchant records correspond to new subscribers or to a recurring subscriber). The merchant records may include transaction records relating to anything relevant to creating a subscriber account, including, for example, the merchant identifier, merchant subset identifier (such as, for example, the specific merchant store or location), new/existing subscriber unique identifier (such as, for example, email address, phone number, name). The new/existing subscriber unique identifier may be only one identifier.

Specifically, the merchant gateway 120 of certain embodiments may include the following components and/or logical devices. First, the merchant gateway 120 may include a utility/tool for generating/creating an instance/record of a merchant (such a utility/tool may be referred to as “MGCreatemerchant Tool,” for example) upon receiving a request to do so. Second, the merchant gateway may include APIs for creating instances/records for new subscribers/users and for receiving payments (such APIs may be referred to as “MGRestApi,” for example). These APIs may be REST APIs for performing queries, as described in more detail below. The subscriber may pay via any acceptable means at the merchant site, including credit card, debit card, prepaid card, cash, check, paypal, google wallet, wepay, 2checkout, skrill, intuit, propay, click2sell, and the like.

Third, the merchant gateway may include a database for storing requests. The requests may correspond to requests from the REST APIs. The database may be any kind, including a MongoDB™ database, for example. The database may also perform ETL (extract transform & load) functions, which may present subscriber data to the DWH for subscriber verification purposes.

Fourth, the merchant gateway may include a program that runs as a background process rather than being under the direct control of an interactive user (such as a daemon, for example) for processing requests from a queue. As discussed in more detail below, the requests may include requests to: (1) create a record/instance of a new subscriber, (2) process payments for new subscribers, and/or (3) process payments for existing subscribers, for example. As new requests are made, the new requests may be added to the queue for processing. The program may be referred to as “MGDaemon,” for example.

Fifth, the merchant gateway of certain embodiments may include a database for storing transaction details. Such transaction details may be any relating to the transaction (date, time, method of payment, user data, merchant data, time to process transaction, whether current or prior payment method failed, time in queue, and the like). The database for storing the transaction details may be referred to as “MGDB,” for example.

Sixth, the merchant gateway may include a utility/tool to generate reconciliation reports. Operators (of the content delivery networks) may use the reconciliation reports to audit/check the activities of the merchants. For example, the operators may refer to the reconciliation reports to determine how many new subscribers a merchant has originated and/or to determine how much payment a merchant has collected, for example. The utility/tool for generating the reconciliation reports may be referred to as “MGReportTool,” for example. With certain embodiments, the utility/tool that generates reconciliation reports may be a CLI tool.

With regard to the “MGCreateMerchantTool,” this utility/tool may be a part of the utilities/tools that are used by an administrator of the operator. When generating a new instance/record of a new merchant, the operator (or merchant) may be prompted to enter some or all of the following fields: (1) a merchant name, (2) a merchant e-mail address, (3) a merchant address, and/or (4) a telephone number for the merchant. For each new merchant, the entered information for these fields may be stored as a part of the record for each new merchant.

In certain embodiments of the present invention, once the “MGCreateMerchantTool” receives the entered information for the fields, the “MGCreateMerchantTool” may then return an identifier that may uniquely identify the merchant (such as a “Merchant ID,” for example). The “MGCreateMerchantTool” may also return a password for the merchant (such as a “Merchant API Key,” for example). Once a merchant receives a Merchant ID and a Merchant API Key, the merchant may then access the merchant gateway.

With certain embodiments of the present invention, merchant details may be saved in a merchant collection in a database (DB). Specifically, merchant details may be saved in a merchant table in MGDB.

With regard to “MGRestAPI,” MGRestAPI can be utilized by third parties/merchants to generate a record/instance for a new subscriber. When creating a new record/instance for a new subscriber, MGRestAPI may receive the following inputs: (1) an identifier that uniquely identifies the new subscriber (which may be referred to as “apiKey,” for example), (2) an identifier that identifies the merchant that originated the subscriber (which may be referred to as “merchantId,” for example), (3) merchantPopId (optional), and/or (4) a username (such as an email address) for the new subscriber. “MerchantPopId” can generally refer to a point-of-presence (Pop) identifier. This identifier enables identification of a specific owner of a location (such as a store owner, for example). This identifier provides additional information for tracking the parties involved in each transaction.

Upon receiving the inputs for generating a record/instance for the new subscriber, before the record/instance is generated, MGRestAPI may first check if the new subscriber already exists within the system. For example, MGRestAPI may check whether the username, email address, name or account number of the new subscriber already exists within the system.

After checking if a new subscriber already exists within the system, MGRestAPI may then return a true or false indication that corresponds to whether or not the subscriber already exists within the system (“true” if the subscriber does not yet exist, and “false” if the subscriber already exists within the system, or vice-versa). It may also, for example, suggest alternative spellings of the subscriber information to determine if the merchant mistyped the information. With certain embodiments, MGRestAPI checks with a database to determine whether or not a username (or whether or not an email) already exists within the system.

In the event that a new subscriber is determined to be added, MGRestAPI may receive information for some or all of the following inputs/fields: (1) a unique identifier that identifies the subscriber (apiKey), (2) an identifier that identifies the merchant that originates the subscriber (merchantId), (3) merchantPopId (optional), (4) a username (or email) of the subscriber, (5) a firstName of the subscriber, (6) lastName of the subscriber, (7) telephone number of the subscriber, (8) an amount of payment of the subscriber, (9) type of currency used to provide payment, (10) a submitTime (UTC) corresponding to the time that the new subscriber is added, and/or (11) a merchantReferenceId (optional).

After the MGRestAPI adds the new user, the request is put in the queue and API may return a 200 OK indication. A 200 OK indication may indicate that the request has been received and put into the queue, but has not yet been processed. Putting requests in the queue provides a “fire and forget” approach to message processing. With this approach, the end user (such as a merchant, for example) does not have to keep a persistent connection or be concerned about the current status of the transaction. The transaction may be completed by the intelligence on a main site 130 side of the system (such as the YipTv-side of the system, for example). An appropriate state of the subscriber will be provided when the subscriber logs into the system. One possible advantage of using this approach is that a large capacity of messages may be sent and may be processed without interrupting the flow of the process. In a very large transactional system (where hundreds or even thousands of requests are processed each second), the parties situated at the far end (such as the merchants, in this case) will generally not have to wait for the transaction to complete in this process. Rather, the merchants will know that their requests will be processed in a queue like feature. In certain embodiments, the queue may use a first in first out (FIFO) processing structure, but the queue can also be further configured to prioritize the processing based on weighted processing.

If the username (corresponding to the new subscriber to be added) already exists within the system, then the transaction status may be set to “failed,” and a reason for the failure may be set to “username-exists” (i.e., the username already exists within the system). If any of firstName, lastName, telephone, and/or username of the new subscriber fails a validation process, the transaction status can be set to “failed,” and the reason for the failure may be set to “input-error.” One example of an instance where the input would result in an error is if the input contains a number of characters that exceed a maximum length. Another example of an instance where the input would result in an error is if the input contains non-allowable characters.

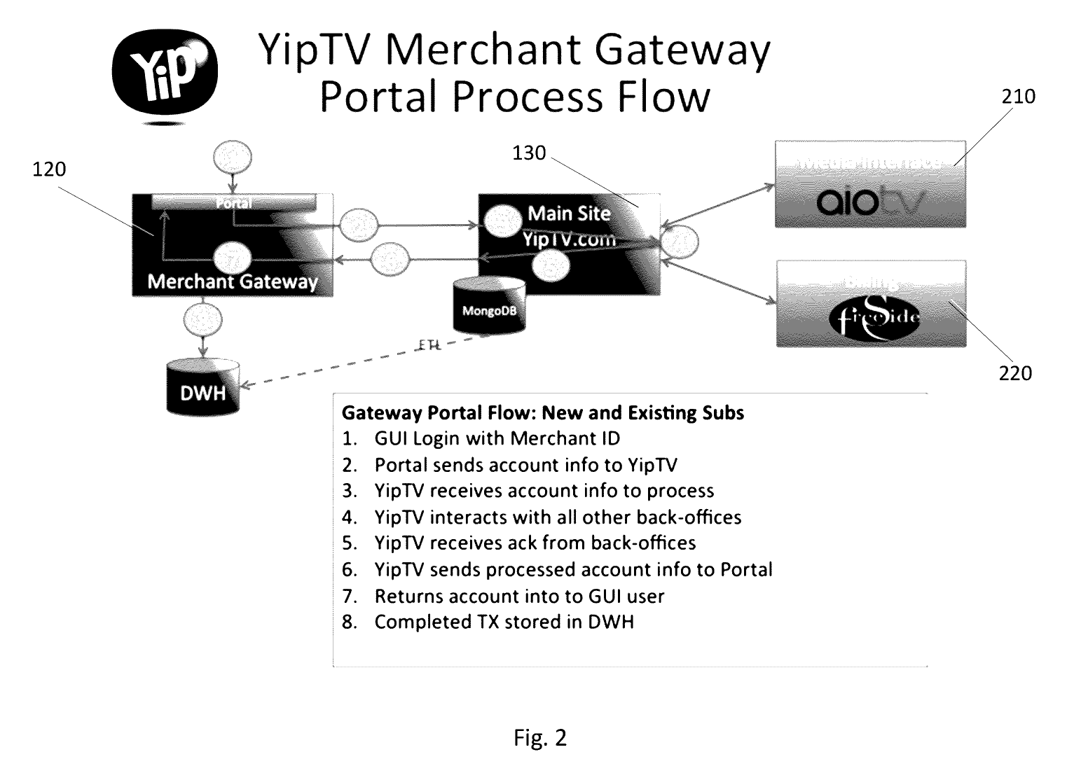

If all validations are passed, a new record/instance for the new subscriber is created in a database. FIG. 2 illustrates an arrangement between a merchant gateway 120, media interface 210, and a billing utility 220, in accordance with certain embodiments of the present invention. Media interface 210 may be any video content platform that allows aggregating traditional linear, internet video and VOD content into a scalable video service utilizing an internet or wifi connected device. Billing utility 220 may be FreeSide, for example. If the new subscriber has provided payment, and amount is credited to the user, the transaction status may be set to “success.” In FreeSide, the address may be set to “Merchant Gateway—<merchant-id>” and the Billing Type (payby) may be set to “PREPAY.”

When MGRestAPI creates the new subscriber/user, the MerchantID of the merchant that has originated the new subscriber/user is stored in MGDB and the database. Once the new subscriber/user is signed up, an e-mail may be sent to the new subscriber/user. The new subscriber/user can then click a link in the e-mail, and the new subscriber/user can enter a password to confirm his or her account. The transaction details and the status (regarding whether the new subscriber/user was successfully registered or not) are stored in MGDB in both User and Payment tables.

In order for the merchant to enter payments made by the subscriber, the merchant may enter certain fields relating to the payment. The merchant may input one or more of the following fields: apiKey, merchantId, merchantPopId,username (email), amount, currency, submitTime (UTC), and/or merchantReferenceId.

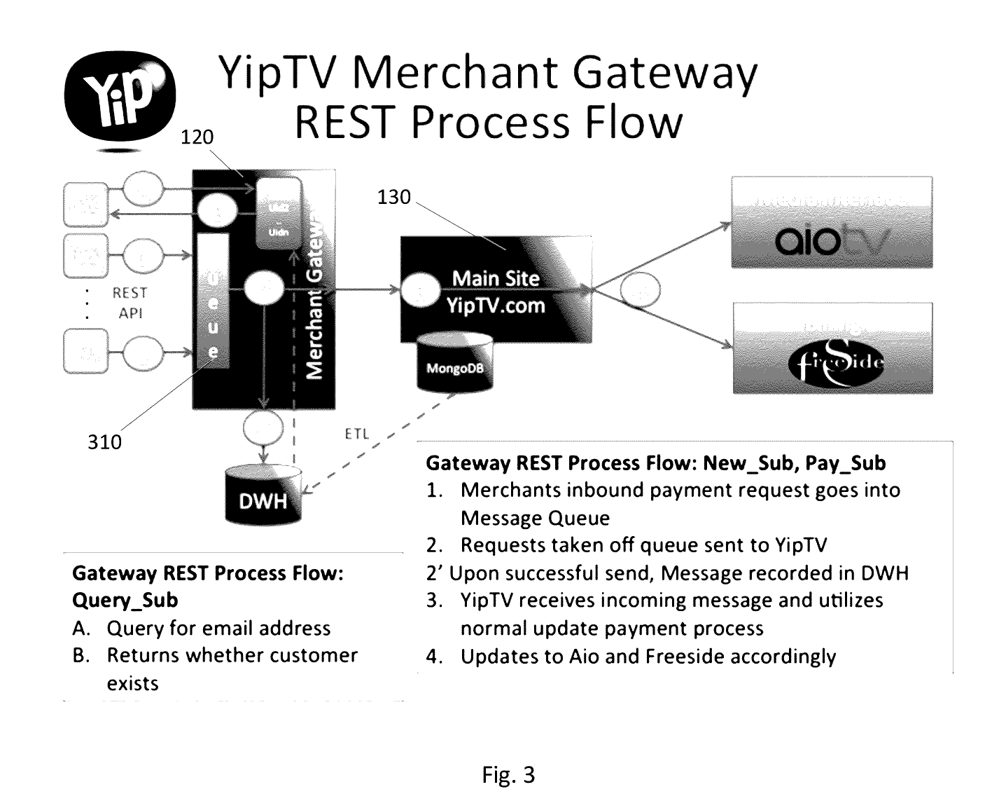

Once the above-described request is put into the queue, the MGdaemon may then read the request from the queue, make a payment and update a status in DB, media interface 210 and billing utility 220. The API will return 200 OK after adding the request to the queue. FIG. 3 illustrates a merchant gateway 120 that utilizes a queue 310, in accordance with certain embodiments of the present invention.

When entering payments, if the username (or email) that corresponds to the payments does not exist, then the transaction status may be set to “failed,” and the reason for the failure may be set to “username-not-found.” If the amount of the payments is not expressed in correct increments (such as not being in multiples of payments of $14.99/month, for example), then the transaction status may be set to “failed,” and the reason for the failure may be set to “input-error.” If the user status is “failed,” then the transaction status may be set to “failed,” and the reason for the failure may be set to “account-error.”

If a user type is “free” (corresponding to a user with a free trial period), and the user's status is “registered”, “active,” or “trial-ended,” then the user may be upgraded to being a paid user. If the user type is “paid,” and the status is “canceled,” the user can be re-activated from the cancelled status. If user type is “comp” (corresponding to a user who has received a “complementary” subscription), and the status is “registered” or “active,” the transaction status may be set to “failed” and the reason may be set to “active-account.” If the user type is “comp” and status is “comp-ended,” the user may be upgraded to being a paid user. A amount of payment may be credited to the user in FreeSide. In FreeSide, the address may be set to “Merchant Gateway—<merchant-id>” and the Billing Type (payby) may be set to “PREPAY.” Any credit card details that are previously stored may be deleted once a payment type is set to PREPAY.

The transaction details and the status (whether the payment was successfully submitted or not) are stored in MGDB in Payment table. When payment is made via MGRestAPI, the MerchantlD responsible for the payment may be stored in MGDB.

With regard to MGQueue, a MongoDB based queue (monq) may be used to determine which add-user and which make-payment requests may be added to. The queue may be persistent so that there are no (or so that there are minimal) data losses. A persistent queue is a mechanism in which the information (data) that resides on the queue is safe-stored into a persistent storage area (such as a disk or a redundant random access memory, for example). One possible advantage of having persistence in the queueing mechanism is that requests can be sent to the system and guaranteed to be within the system and processed, without further intervention from an originating messenger (such as a merchant, for example).

With regard to MGDaemon, with certain embodiments, this daemon may listen to new add-user and make-payment requests in the MGQueue, and the daemon may process the requests. The daemon may update the MGDB with the status.

With regard to MGDB, MGDB may be a MySQL relational database management system (RDBMS) where all transactions and their statuses are stored. The DB may have the following tables: (1) Merchants, (2) Users, and (3) Payments.

With the Merchants table, the columns may include some or all of the following: Id, Name, Email, Address, Telephone, ApiKey, and MerchantId.

With the Users table, the columns may include some or all of the following: Id, Username, MerchantId (indicating that the subsriber/user was originated by a certain merchant), MerchantPopId (optional), Status, Reason

With the Payments table, the columns may include some or all of the following: Id, Amount, Currency, MerchantId, MerchantPopId (optional), Username, IsUserOwned (was user created by the same merchant or not), Status, Reason.

With regard to MGReportTool, MGReportTool may be a CLI tool that is a part of the administrative tools. To generate a report, the user may enter a command such as “node mg-reports.” The user may then be asked to enter some or all of the following: (1) Merchant Id, (2) Start Date, and/or (3) End Date.

In certain embodiments, the tool may output a file with specified fields. For example, one embodiment of the present invention may output a comma-separated variable (CSV) file with some or all of following fields: (1) MerchantReferenceId, (2) MerchantPopId, (3) Username, (4) Amount, (5) Currency, (6) SubmitTime (UTC), (7) ProcessTime (UTC), (8) Status (success/fail), and/or (9) Reason (empty if success).

In certain embodiments, the file name may be <merchant-id>-<start-date>-<end-date>.csv.

With regard to hosting, the components of the Merchant Gateway may be designed such that the gateway can be hosted independently or along with other website components.

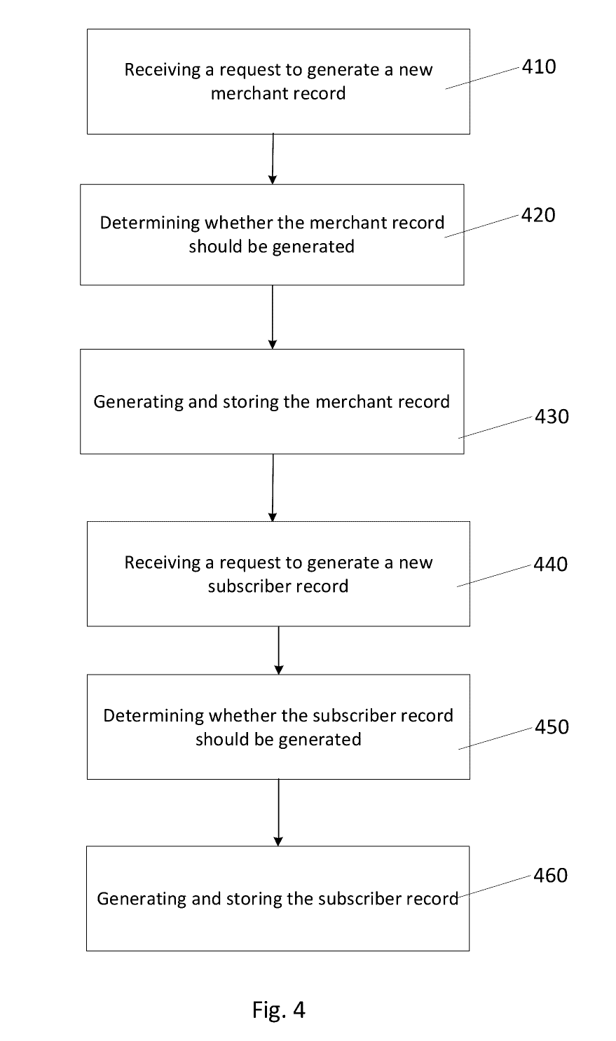

FIG. 4 illustrates a flowchart of a method in accordance with certain embodiments of the invention. The method illustrated in FIG. 4 includes, at 410, receiving, by a network device, a request to generate a new merchant record for a merchant, wherein the request is received from a location of the merchant. The method also includes, at 420, determining whether the merchant record should be generated. The method may also include, at 430, generating and storing the merchant record based upon the first determination. The method may also include, at 440, receiving a request to generate a new subscriber record for a subscriber. The request is received from the location of the merchant. The subscriber record indicates an association between the subscriber and the merchant. The method may also include, at 450, determining whether the subscriber record should be generated. The method may also include, at 460, generating and storing the subscriber record based upon the second determination.

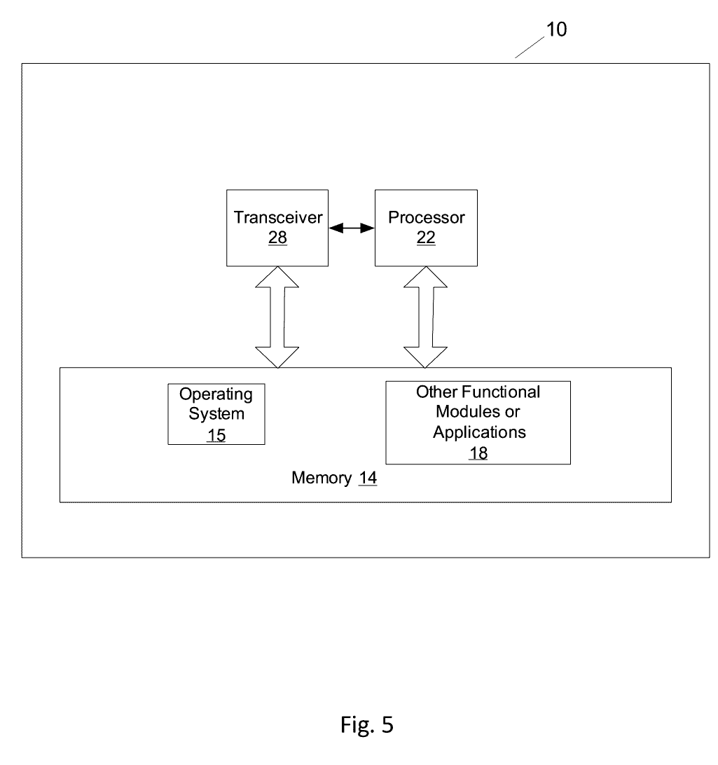

FIG. 5 illustrates an apparatus in accordance with certain embodiments of the invention. In one embodiment, the apparatus can correspond to merchant gateway 120, for example. Apparatus 10 can include a processor 22 for processing information and executing instructions or operations. Processor 22 can be any type of general or specific purpose processor. While a single processor 22 is shown in FIG. 5, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources. For example, apparatus 10 may perform the method illustrated by FIG. 4.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

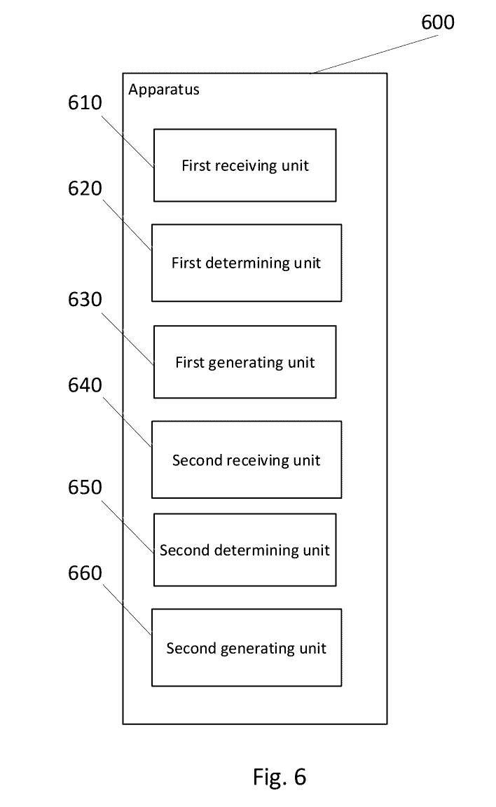

FIG. 6 illustrates an apparatus in accordance with certain embodiments of the invention. Apparatus 600 can be a network element/entity such as a merchant gateway, for example. Apparatus 600 can include a first receiving unit 610 that receives a request to generate a new merchant record for a merchant. The request is received from a location of the merchant. Apparatus 600 can also include a first determining unit 620 that determines whether the merchant record should be generated. Apparatus 600 may also include a first generating unit 630 that generates and stores the merchant record based upon the first determination. Apparatus 600 may also include a second receiving unit 640 that receives a request to generate a new subscriber record for a subscriber. The request is received from the location of the merchant, and the subscriber record indicates an association between the subscriber and the merchant. Apparatus 600 may also include a second determining unit 650 that determines whether the subscriber record should be generated. Apparatus 600 may also include a second generating unit 660 that generates and stores the subscriber record based upon the second determination.

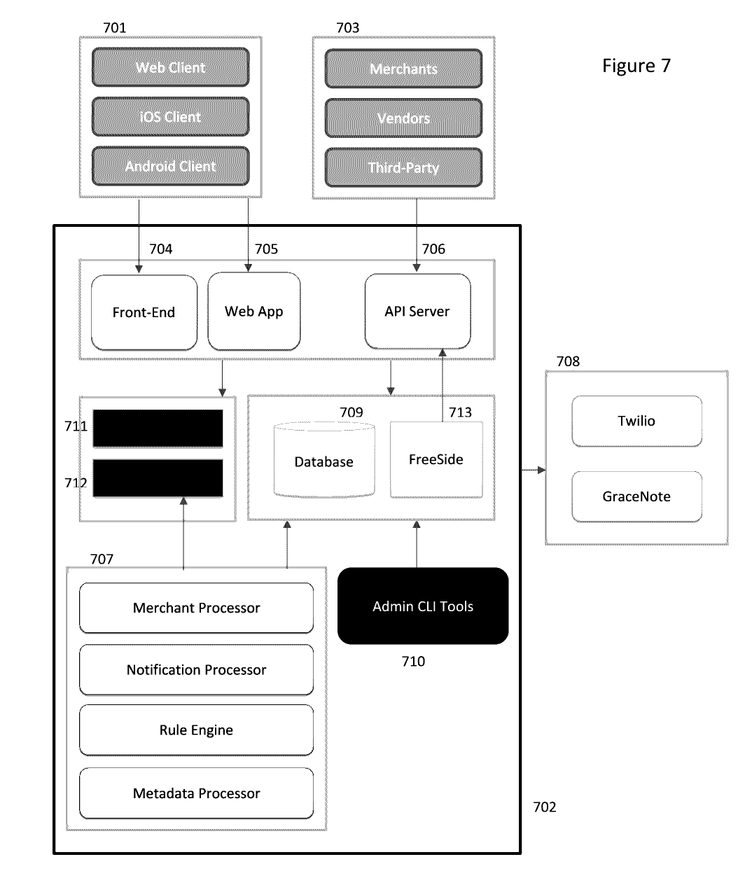

FIG. 7 illustrates a system in accordance with certain embodiments of the invention. The system can have one or more types of client 701. One client is a web client which allows users to view on demand or continuous streaming channels and manage their subscription using web browsers, such as Chrome, Firefox, Safari, Internet Explorer, and the like. The client 701 may alternatively be an iOS client, which allows users to watch on demand or continuous streaming channels and manage their subscription on their personal Internet connected devices, such as, for example, iPhones and iPads. The client 701 may alternatively be an Android client, which allows users to watch on demand or continuous streaming channels and manage their subscription on Android devices. The client 701 may receive subscribers/customer information, channel content and channel information from the server 702.

The system may likewise access third party systems 703, such as those run by merchants, vendors or third-parties. In one embodiment, the third party system 703 comprises a merchant gateway.

The system may also contain software that presents a main website front end 704 for any third party to view. The front end 704 may contain information such as channel line ups, free and premium sign up pages and provides information about the content provider. The system may also contain an internet web application 705 that provides all the APIs that are utilized or required by subscribers/customers. The system may also contain an API server 706, which is capable of hosting all APIs other than internet web application 705 APIs, such as Merchant Gateway APIs and Notification APIs.

The server 702 also contains one or more software algorithms or daemons 707. The daemons 707 may include a Merchant Processor Daemon, which includes APIs capable of being processed offline, like payment and refund APIs. These APIs when called add a request to a task queue, and the requests are processed by the Merchant Processor Daemon. The daemons 707 may also include a Notification Processor Daemon, whose APIs may be processed on line or off line. The daemons 707 may also include a Rule Engine Daemon that executes software actions upon a schedule, such as once a day, every eight hours, or the like, and if certain facts that meet the criteria. Some of the tasks performed by the Rule Engine Daemon may include: send emails to free user asking them to upgrade; canceling premium subscription on last day of the billing cycle; canceling complimentary subscription on the last day; removing premium package on 8th day of free subscription; and the like. One other daemon 707 may be the Metadata Processor Daemon which also executes on a schedule to fetch program guides for on demand or continuous broadcast content from

The metadata processor executes once every day and fetches information from third parties information providers 708. Such third parties information providers 708 may include program guide information for channels such as entertainment metadata, such as Gracenotes, or provide services to allow software developers to programmatically make and receive phone calls and send and receive text messages, such as Twilio. The information from the third party information providers 708 can then be stored in the database 709.

The system further comprises Administrative CLI tools 710 which perform administrative tasks in the absence of an administrative portal. The tasks can be items such as creating complimentary codes, creating API clients, creating merchants, resetting passwords and generating various reports.

The system further comprises an email server 711, used to handle internal, ingoing and outgoing emails, and a Content Management System 712, or CMS, to handle content management (ads, CDNs, content channels, channel packages, metatags and the like). A billing system 713 is also contemplated.

The arrows shown in FIG. 7, and all other arrows, designate communication between devices or portions of a device, and the arrow point can be indicative of direction of information flow. One skilled in the relevant art will recognize that the arrows may be reversed, or may be bi-direction, with regards to information flow. In addition, the communication between devices can be hardwired or wireless. The communication may be by wireless personal area networks such as Bluetooth, wireless local area network such as those marketed under the IEEE 802.11 WLAN standard, wireless mesh network, wireless metropolitan area networks, global area networks such as cellular networks, and the like.

The APIs provided by the Internet web application 705 include APIs for broadcast or on demand channels, user/subscriber packages and program guides for the channels. For instance, the APIs may call the URL of the channel along with a token, the program guide for a channel, return a list of channels a user/subscriber has subscribed to, return a list of advertisements to be displayed on the client. And return a list of tags associated with a channel, where the tags can be used for filtering purposes on the client (country, on demand or streaming content, language, and the like).

The system may also contain Merchant Gateway APIs for numerous functions. Upon a merchant entering information about a current or new subscriber, the APIs check if a username exists, validate merchant credentials via the merchant ID and API key, records if a payment was made, records refunds, and the like. Some of the merchant Gateway APIs like make-payment and make-refund are processed offline, and when called the APIs add the request to the queue.

The web client allows users/subscribers to view the on demand or continuous broadcast channels and manage their subscripting using a web browser such as Chrome, Firefox, Safari or IE.

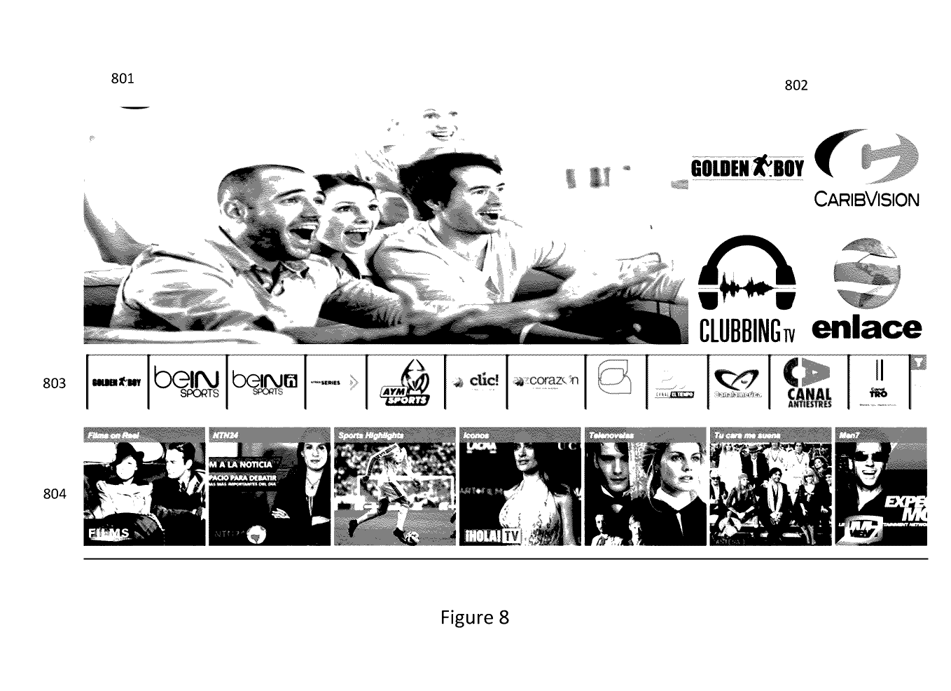

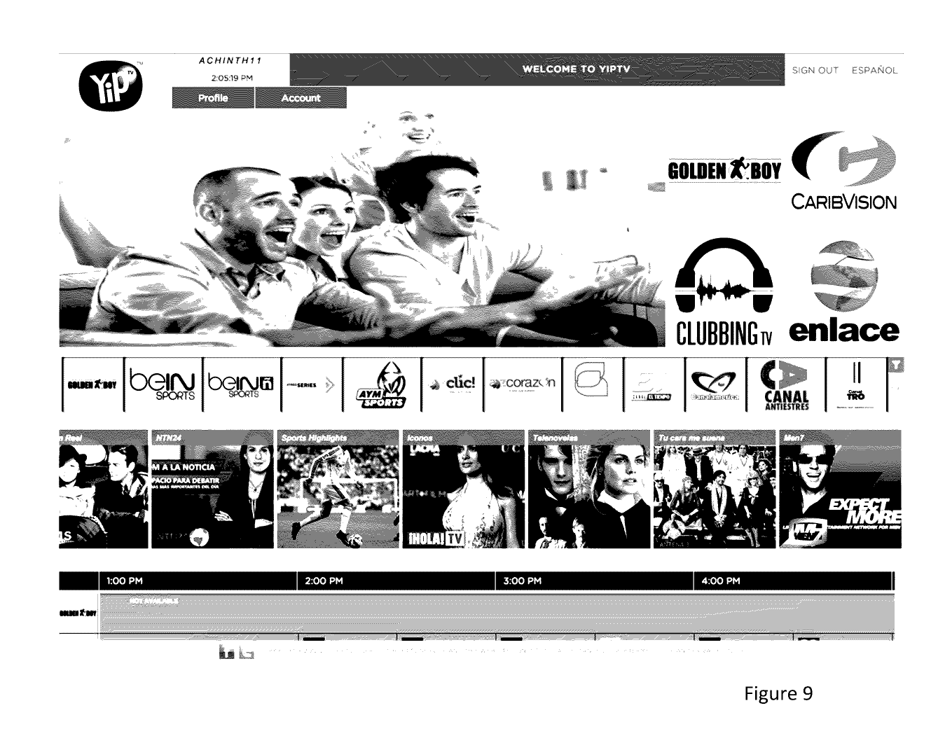

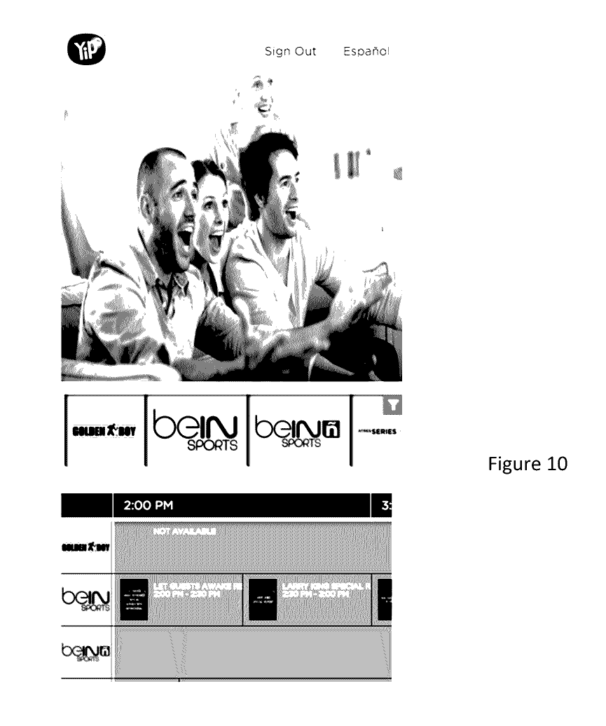

Upon logging in, a user/subscriber will be shows the channel player, as shows in FIG. 8. The channel player contains a screen or player 801 for showing the on demand or continuous broadcast content. Also displayed is the favorite channels 802 of the user/subscriber, a channel viewer 803 displaying a list of channels available to view, and a promotions viewer 804. Notably, it is contemplated that upon a mouse hovering over any channel in the channel viewer 803, the first available program to be watched for that selected channel is displayed. A mouse click onto a channel in the channel viewer 803 also opens up a channel guide for that channel, showing the upcoming shows to be viewed. Upon a mouse click upon a program in the channel guide, the player 801 will display the channel. It is also contemplated that channel content may be searched by language, category, availability, and the like. A mouse hovering on the promotions viewer 804 would result in a pop up box with more details on the promotions. Alternative views of the channel player are further illustrated in FIGS. 9 and 10.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. We claim:

1. A method, comprising:
receiving, by a network device, a request to generate a new merchant record for a merchant, wherein the request is received from a location of the merchant;
determining whether the merchant record should be generated;
generating and storing the merchant record based upon the first determination;
receiving a request to generate a new subscriber record for a subscriber, wherein the request is received from the location of the merchant, and the subscriber record indicates an association between the subscriber and the merchant;
determining whether the subscriber record should be generated; and
generating and storing the subscriber record based upon the second determination.

2. The method according to claim 1, wherein the network device comprises a merchant gateway.

3. The method according to claim 1, further comprising generating and storing a payment record, wherein the payment record reflects a payment by the subscriber, and each payment record is stored into a queue to be processed by a daemon program.

4. The method according to claim 1, further comprising generating a reconciliation report for the merchant, wherein the reconciliation report indicates subscribers that the merchant has originated, and the reconciliation report indicates payments received by the merchant.

5. The method according to claim 1, wherein the generating and the storing the subscriber record comprises utilizing representational state transfer application programming interfaces.

6. The method according to claim 1, wherein the subscriber record indicates whether the merchant originated the subscriber or whether the subscriber is an existing subscriber.

7. The method according to claim 1, wherein the determining whether the merchant record should be generated comprises determining whether the merchant record has already been previously generated.

8. An apparatus, comprising:
at least one processor; and
at least one memory including computer program code,
the at least one memory and the computer program code configured, with the at least one processor, to cause the apparatus at least to
receive a request to generate a new merchant record for a merchant, wherein the request is received from a location of the merchant;
determine whether the merchant record should be generated;
generate and store the merchant record based upon the first determination;
receive a request to generate a new subscriber record for a subscriber, wherein the request is received from the location of the merchant, and the subscriber record indicates an association between the subscriber and the merchant;
determine whether the subscriber record should be generated; and
generate and store the subscriber record based upon the second determination.

9. The apparatus according to claim 8, wherein the apparatus comprises a merchant gateway.

10. The apparatus according to claim 8, wherein the apparatus is further caused to generate and store a payment record, wherein the payment record reflects a payment by the subscriber, and each payment record is stored into a queue to be processed by a daemon program.

11. The apparatus according to claim 8, wherein the apparatus is further caused to generate a reconciliation report for the merchant, wherein the reconciliation report indicates subscribers that the merchant has originated, and the reconciliation report indicates payments received by the merchant.

12. The apparatus according to claim 8, wherein the generating and the storing the subscriber record comprises utilizing representational state transfer application programming interfaces.

13. The apparatus according to claim 8, wherein the subscriber record indicates whether the merchant originated the subscriber or whether the subscriber is an existing subscriber.

14. The apparatus according to claim 8, wherein the determining whether the merchant record should be generated comprises determining whether the merchant record has already been previously generated.

15. A computer program product, embodied on a non-transitory computer readable medium, the computer program product configured to control a processor to perform a method according to any of claims 1-7.
